(19) United States
(12) Patent Application Publication
(10) Pub. No.: US 2026/0063976 A1
(43) Pub. Date: Mar. 5, 2026

(54) MOBILE DEVICE BASED LIGHT DIFFUSER FOR RADIATION MEASUREMENTS

(71) Applicant: Lightray Innovation GmbH, Wiesendangen (CH)

(72) Inventors: Dominik Maglia, Wiesendangen (CH); Dennis Briner, Wiesendangen (CH)

(73) Assignee: Lightray Innovation GmbH, Wiesendangen (CH)

(21) Appl. No.: 18/820,817

(22) Filed: Aug. 30, 2024

(51) Int. Cl. G03B 17/56; G03B 11/04

(52) U.S. Cl. CPC G03B 17/566; G03B 11/041; G03B 17/565

(57) ABSTRACT

A light diffuser device includes a first arm which includes a first pin connector and a second pin connector. The light diffuser device further includes a second arm which includes a first pin connector and a second pin connector. A light diffuser head may be connected to the first arm. An optical lens is disposed in the light diffuser head. The first arm and the second arm form a clip operated by spring pressure. The light diffuser head includes a connector which allows the light diffuser head to connect to the first arm. The optical lens adjusts at least one optical property of light entering the optical lens. The light diffuser device attaches to a mobile device. The optical lens is applied over a camera lens of a camera in a mobile device.

### BACKGROUND

One of the fundamental processes of the Earth is photosynthesis. Photosynthesis is fundamental because photosynthesis provides suitable living conditions for all life on Earth. While photosynthesis is studied even by children in elementary schools, intentionally creating conditions where photosynthesis can occur in practice can be complicated.

Photosynthesis is a process that plants use to convert light energy into chemical energy. Green plants receive light energy from the sun and turn that light energy into molecular compounds including sugars, glycogen, cellulose, and starches, for example. A main byproduct of photosynthesis is oxygen that is created by the chemical process of converting light energy into molecular compounds. This oxygen is the source of most breathable air on Earth. Plants use these molecular compounds to fuel their metabolic requirements, using cellulose and starches to create new plant structures, as well as an energy source for growth and cellular respiration. Nature has created photosynthesis as a balanced and important process for life on earth.

Humans have relied on plant life, intentionally and unintentionally as long as humans have existed on earth. Humans have intentionally used plants for food and to create tools, while unintentionally relying on the oxygen produced by those plants as a byproduct of photosynthesis, for breathing. Over time, humans began to cultivate plants to serve as resources for food, tools, or even for their beauty as decorative. Ancient history contains records of houseplants in ancient Egypt, ancient Greece, Roman civilization, and Chinese civilization. While it is possible that some of these houseplants were intended to bear fruit, many were purely for decorative effect, even in ancient history.

More recently, houseplants became popular in Europe as trade routes grew during the Renaissance. Houseplants became associated with affluence, especially for plants which were transported from far off locations. This trade in houseplants grew to an appreciation of exotic plants, many of which were cultivated outdoors on large properties to provide fruits that were otherwise unavailable for the people of Europe. Books of the period described the care and cultivation of houseplants, as the cost of houseplants came down and houseplants became more popular with less affluent people.

Significant efforts have been expended to provide plants with what they need inside of buildings. For example, in order to provide fruit in the winter, many farms operate large greenhouses inside specifically to produce fruit at any time of year. To accomplish such a feat, the farms must be specifically and carefully arranged with appropriate light, soil, and water to allow the plants to accomplish photosynthesis. The most difficult variable to correctly determine is the light because the light must have the correct intensity for an appropriate duration, the correct spectrum of light, and correct placement, for a specific plant. Light utilized by plants for photosynthesis is known as “photosynthetically active radiation” or “PAR”. PAR comprises photons with wavelengths between 400 and 700 nanometers (nm). The intensity of PAR reaching a surface, such as plant leaves, is quantified as photosynthetic photon flux density or “PPFD”. Achieving the right amount of PPFD has been difficult for many plant cultivators, especially those that rely on the plants to produce a crop.

As a result, plant cultivators have begun to use various tools to identify the characteristics of light in their indoor gardens. PAR meters have been created as handheld meters that may be used to evaluate light intensity in a specific space to determine whether or not the light is appropriate for successfully growing plants. These meters include a light diffuser which may be adjustable to ensure that light intensity is evenly measured and accurately detected. Other conventional solutions have included ambient light sensors or cameras which operate on mobile devices to detect certain characteristics of light in a particular location. Ambient light sensors and cameras, however, generally lack cosine correction and are only poorly matched to a spectral sensitivity standard. Ambient light sensors are further limited in their range and can be not well linearly corrected, which prevents their use for accurate light intensity measurements in many applications.

Dedicated light meters are typically difficult to use for any untrained user and are quite costly to the point that many recreational cultivators would rather rely on generic lighting recommendations and visual inspection of their plants. While the following disclosure may be used specifically for use in measuring photosynthetic conditions, it is noted that light meters can be used for any type of light intensity measurements, including theatrical or event staging, home lighting levels, office lighting levels, or for any other purpose where light intensity measurements are relevant or useful. Accordingly, the market requires a solution that makes light analysis simple, accurate, and available to everyone in terms of costs.

It is therefore one object of this disclosure to provide a light diffuser device which may be attached to a mobile device for providing accurate light measurements, hence forming a light meter as a result. It is another object of this disclosure to provide a light diffuser device which may be easily installed and uninstalled on a mobile device. It is another object of this disclosure to provide a light diffuser which operates in concert with a camera in a mobile device to perform light analysis.

### SUMMARY OF THE DISCLOSURE

Disclosed herein is a light diffuser device. The light diffuser device includes a first arm which includes a first pin connector and a second pin connector. The light diffuser device further includes a second arm which includes a first pin connector and a second pin connector. A light diffuser head may be connected to the first arm. An optical lens is disposed in the light diffuser head. The first pin connector and the second pin connector of the first arm and the first pin connector and the second pin connector of the second arm include pin apertures which are connected by a cross pin. A spring is disposed on the cross pin to provide spring pressure to bias the bottom end of the first arm and the bottom end of the second arm towards each other. The cross pin acts as a pivot to form a clip. The light diffuser head includes a retainer which selectively retains the optical lens in the light diffuser head. The light diffuser head includes a connector which allows the light diffuser head to connect to the first arm. The optical lens adjusts at least one optical property of light entering the optical lens.

### BRIEF DESCRIPTION OF THE DRAWINGS

Non-limiting and non-exhaustive implementations of the disclosure are described with reference to the following figures, wherein like reference numerals refer to like parts throughout the various views unless otherwise specified. Advantages of the disclosure will become better understood with regard to the following description and accompanying drawings where:

FIG. 1 illustrates a front view of a light diffuser head.

FIG. 2 illustrates a rear view of a light diffuser head.

FIG. 3 illustrates a side view of a light diffuser head.

FIG. 4 illustrates a front view of a light diffuser device.

FIG. 5 illustrates a rear view of a light diffuser device.

FIG. 6 illustrates a bottom view of a light diffuser device.

FIG. 7 illustrates a top view of a light diffuser device.

FIG. 8 illustrates a partially exploded view of a light diffuser device.

### DETAILED DESCRIPTION

In the following description of the disclosure, reference is made to the accompanying drawings, which form a part hereof, and in which is shown by way of illustration specific implementations in which the disclosure may be practiced. It is understood that other implementations may be utilized, and structural changes may be made without departing from the scope of the disclosure.

In the following description, for purposes of explanation and not limitation, specific techniques and embodiments are set forth, such as particular techniques and configurations, in order to provide a thorough understanding of the device disclosed herein. While the techniques and embodiments will primarily be described in context with the accompanying drawings, those skilled in the art will further appreciate that the techniques and embodiments may also be practiced in other similar devices.

Reference will now be made in detail to the exemplary embodiments, examples of which are illustrated in the accompanying drawings. Wherever possible, the same reference numbers are used throughout the drawings to refer to the same or like parts. It is further noted that elements disclosed with respect to particular embodiments are not restricted to only those embodiments in which they are described. For example, an element described in reference to one embodiment or figure, may be alternatively included in another embodiment or figure regardless of whether or not those elements are displayed or described in another embodiment or figure. In other words, elements in the figures may be interchangeable between various embodiments disclosed herein, whether shown or not.

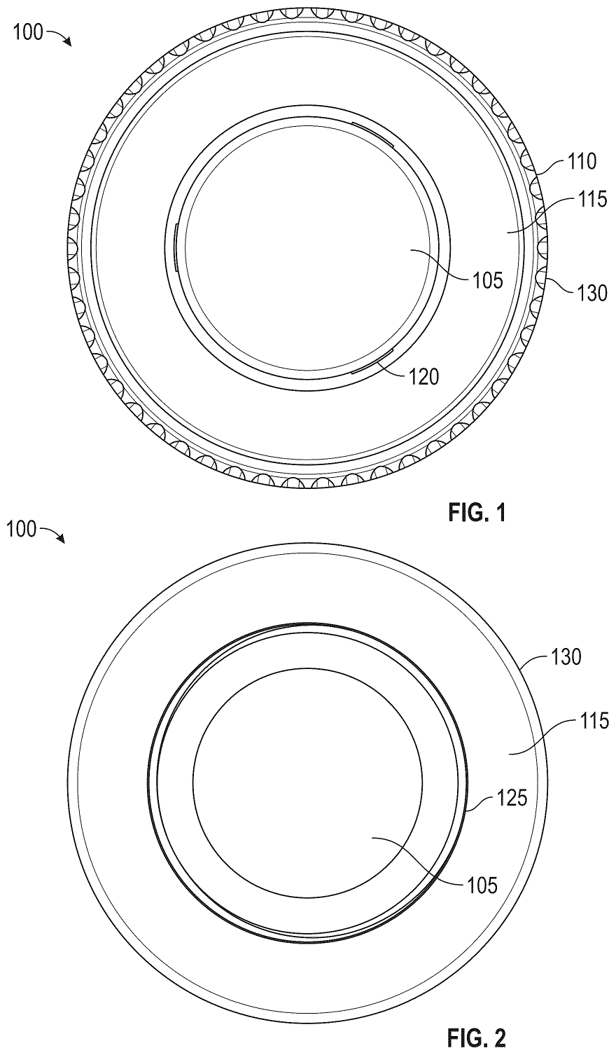

FIG. 1 illustrates front view of a light diffuser head 100. Light diffuser head 100 may be constructed of any natural or synthetic material, including metals, alloys, and plastics. Light diffuser head 100 includes an optical accessory attachment 130 that includes a rim 115 having an edge 110 which may include grip enhancing features, such as knurling, texturing, or any other known technique for increasing grip on a rim 115. Edge 110 may further be raised above rim 115 to provide light blocking from certain angles. Rim 115 of light diffuser head 100 may contain an optical lens 105, which is retained in diffuser head 100 by retainers 120.

Optical lens 105 may be made of a translucent material such as glass, quartz, or certain plastics which provide adjustments to certain characteristics of light. For example, light that passes through optical lens 105 may be scattered. Optical lens 105 may alter optical properties of light, which includes filtering or shifting wavelengths of light, attenuating certain wavelengths of light (e.g., acting as an absorption filter) by coloration of optical lens 105 (which means colored to be not clear as a tool to manipulate light (e.g., if the optical lens is colored (not white), the optical lens may include materials with properties that block some wavelengths of light more than others)), specially coated or made of materials to act as an interference filter to attenuate certain wavelengths of light, specially coated with or made of materials that are excited by ultraviolet or infrared radiation, or other optical shifting properties. It is noted that in some cases, a “lens” and a “diffuser” are referred to as different elements because their respective functionality is different (e.g., focusing light as opposed to diffusing light). For the purposes of this disclosure, an “optical lens” is intended to refer to any transparent or translucent glass, quartz, or plastic structure that can be installed in diffuser head 100, where the selected transparent or translucent glass, quartz, or plastic structure is installed based on the intended use. In this manner an “optical lens” or a “lens” is merely referred to as a transparent or translucent glass, quartz, or plastic structure which applies an optical adjustment to light, whether that adjustment has a light diffusing nature (e.g., a light diffuser), a focusing nature (e.g., a conventional lens), a filtering nature (e.g., a filter), or any other modification of a characteristic of light. Thus, the term “optical lens” or “lens” is intended to be inclusive of any light modifying transparent or translucent glass, quartz, or plastic structure, regardless of what modification it performs on a characteristic of light.

Optical lens 105 may be installed and be removable from rim 115 of light diffuser head 100. In one embodiment, different optical lenses 105 that provide certain modifications of optical properties discussed above may be provided such that one optical lens 105 may be substituted for another, depending on the desires of the user. In another embodiment, optical lens 105 may be disposed as flush with a surface of rim 115. In another embodiment, optical lens 105 may extend above a surface of rim 115 to receive light from various angles to correctly account for light geometry according to Lambert's cosine law. As shown in FIG. 1, an outward facing surface of optical lens diffuser 105 is shaped to be a flat surface or a curved surface.

FIG. 2 illustrates a rear view of light diffuser head 100. As shown in FIG. 2, a rear portion of light diffuser head includes rim 115 and optical lens 105. Light diffuser head 100 allows for light to pass through optical lens 105 and light diffuser head 100 by positioning optical lens 105 within rim 115. Light diffuser head 100 may further include a connector 125, shown as machine threads but not so limited. Any connector known in the art may be used to connect light diffuser 100 to a light diffuser device (discussed below), including a friction based connection, a clip based connection, and a button based connection. Optical lens 105 may be sized to fit over the lenses of cameras associated with mobile devices, such as smart phones, tablets, camera drones, cameras, gaming consoles, laptops, video cameras, or any other electronic device of various makes and models.

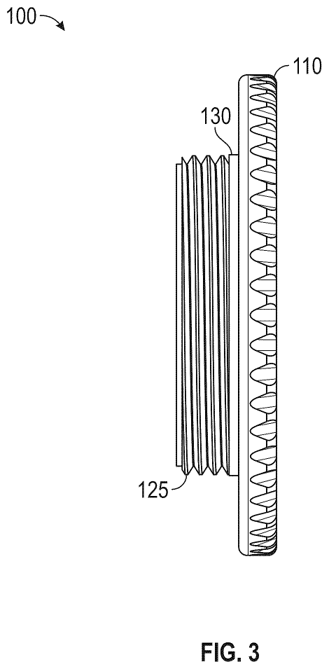

FIG. 3 illustrates a side view of light diffuser head 100. As shown in FIG. 3, light diffuser head 100 includes a grip enhancing feature 110, such as knurling or texturing. Light diffuser 100 further includes a connector 125 for connecting light diffuser head 100 to a light diffuser device, which will be discussed below. As shown in FIG. 3, optical lens 105 is disposed flush with a rim 115 of light diffuser head 100. Optical lens 105 may also be disposed such that optical lens 105 extends beyond rim 115 to receive light from various angles.

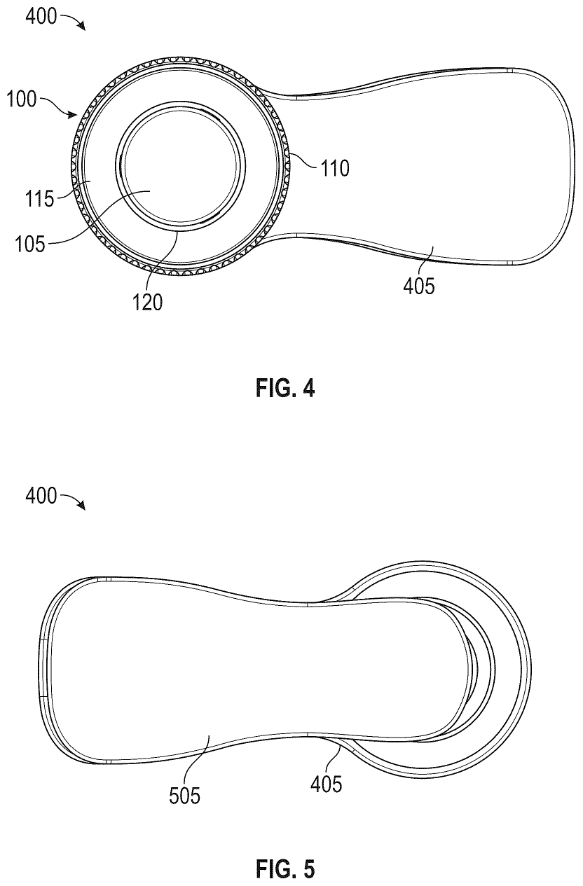

FIG. 4 illustrates a front view of light diffuser device 400. Light diffuser device 400 is implemented as a spring loaded clip, which will be discussed below. Light diffuser device provides a first arm 405 which connects to light diffuser head 100, shown in FIGS. 1-3. For example, first arm 405 may include a connector corresponding to connector 125 of light diffuser head 100. For example, first arm 405 may include corresponding threads to receive threads from connector 125. In this manner, light diffuser head 100 may connect to first arm 405. As previously discussed, light diffuser head 100 includes an optical lens 105, a rim 115 having an edge 110 that may include grip enhancing features including those discussed herein and any other known to those of skill in the art. Grip enhancing features on edge 110 may facilitate connecting light diffuser head 100 to first arm 405. For example, grip enhancing features on edge 110 may enhance the ability of a user to grip light diffuser head 100 to connect light diffuser head 100 to first arm 405 or disconnect light diffuser head 100 from first arm 405.

FIG. 5 illustrates a rear view of light diffuser device 400, which includes a second arm 505. Second arm 505 may be connected to first arm 405 by use of a cross pin, which will be described below. The cross pin may connect to a spring which pushes a top of first arm 405 and a top of second arm 505 away from each other, using the cross pin as a pivot point. Pushing a top of first arm 405 away from a top of second arm 505 necessarily causes a bottom of first arm 405 towards a bottom of second arm 505, functionally making a spring loaded clip between first arm 405 and second arm 505. In one embodiment, first arm 405 may be longer than second arm 505, to ensure that second arm 505 does not interfere with other functionality of a mobile device when light diffuser device 400 is installed on a mobile device.

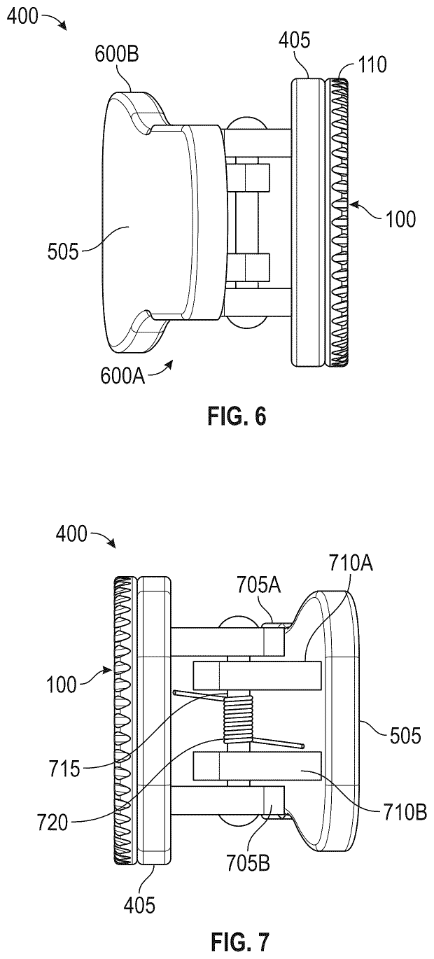

FIG. 6 illustrates a bottom view of light diffuser device 400. As shown in FIG. 6, first arm 405 is connected to light diffuser head 100 by connector 125 and using grip enhancing features 110. First arm 405 is connected to second arm 505, as will be discussed below. However, as shown in FIG. 6, second arm 505 includes a taper along both sides (600A/600B) of second arm 505 (which may be optionally included in first arm 405, shown in FIG. 4 as well). For example, a top end of second arm 505 is wider than a bottom end of second arm 505 by virtue of taper 600A and 600B installed in a side of second arm 505. Taper 600A/600B allows for a wider surface at a top of second arm 505 which may be easier for a user to use. For example, in order to use light diffuser device 400, a user must squeeze a top of first arm 405 and a top of second arm 505 towards each other to compress a spring in the clip and increase a distance from a bottom of first arm 405 to a bottom of second arm 505 to allow light diffuser device 400 to be installed over a camera lens on a mobile device. Providing taper 600A and 600B on a side of second arm 505 allows for a larger surface area for a user to squeeze at a top of second arm 505, which facilitates simple and fast use of light diffuser device 400.

FIG. 7 illustrates a top view of light diffuser device 400. As shown in FIG. 7, first arm 405 includes a first pin connector 705A and a second pin connector 705B. First and second pin connectors 705A may extend from a rear surface of first arm 405 (e.g., a side of first arm 405 opposite of the front side of arm 405 where light diffuser head 100 connects to first arm 405). Similarly, second arm 505 may include a first pin connector 710A and a second pin connector 710B, which extend from a rear surface of second arm 405 towards a rear surface of first arm 405, as shown in FIG. 7. Each one of first pin connector 705A, second pin connector 705B, first pin connector 710A, and second pin connector 710B may include an aperture that allows cross pin 715 to be inserted through first pin connector 705A, second pin connector 705B, first pin connector 710A, and second pin connector 710B. In this manner cross pin 715 connects first arm 405 to second arm 505 where cross pin 715 functions as a pivot point for first arm 405 and second arm 505.

A spring 720 or other elastic member, may be disposed on cross pin 715 to provide pressure that tends to keep a bottom of first arm 405 and a bottom of second arm 505 biased towards each other. Spring 720 may be compressed by squeezing first arm 405 and second arm 505 together by the top end of the respective arms, which causes a bottom of first arm 405 to separate from each other to open the clip of light diffuser device 400.

Light diffuser device 400 is intended to be able to secure itself, by pressure from spring 720 to a mobile device that includes a camera. For example, a user may squeeze first arm 405 towards second arm 505 to open a light diffuser device 400. The user may then place optical lens 105 of light diffuser device 400 over a camera lens associated with the mobile device. Upon releasing pressure from spring 720, first arm 405 and second arm 505 may return towards each other and entrap the mobile device between first arm 405 and second arm 505. Spring 720 applies pressure to maintain light diffuser device 400 in place on the mobile device and optical lens 105 over a camera lens of a camera associated with the mobile device. Optical lens 105 acts as a diffuser, a filter, or otherwise acts to change at least one optical property of light entering optical lens 105. Modified light that passes through optical lens 105 is provided to a camera lens of the mobile device is subjected to further analysis by the mobile device by a software application installed on the mobile device. The software application may provide information to a user about the light being detected by the camera and its relative suitability for creating conditions where photosynthesis is optimized in plants or with any light intensity measurement or analysis conditions.

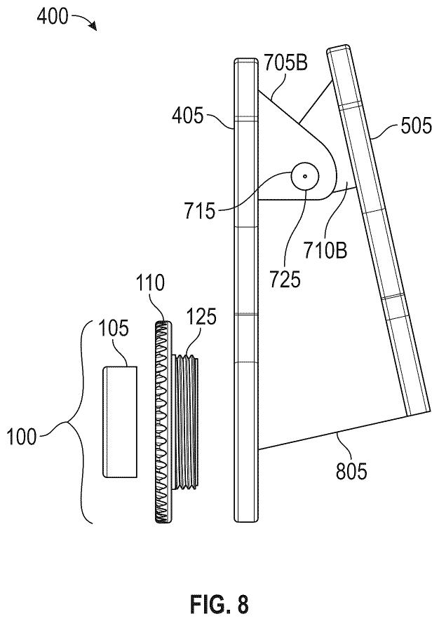

FIG. 8 illustrates a partially exploded view of a light diffuser device 400. As shown in FIG. 8, a light diffuser head 100 includes an optical lens 105 which connects, as previously discussed to an optical accessory attachment 130, having a rim 115 and an edge 110. Optical accessory attachment 130 further includes a connector 125, which allows light diffuser head 100 to connect to first arm 405 of light diffuser device 400 on a front side of first arm 405. Light diffuser device 400 further includes a second arm 505 which may be attached to first pin connector 705A (not shown due to perspective), second pin connector 705B, first pin connector 710A (not shown due to perspective), and second pin connector 710B. Each one of first pin connector 705A, second pin connector 705B, first pin connector 710A, and second pin connector 710B may include a pin aperture 725 which allows cross pin 715 to secure first arm 405 to second arm 505. A spring disposed in light diffuser device 400, around cross pin 715 or otherwise, may be installed which causes a distance 805 between a bottom of first arm 405 and second arm 505 to be changed based on pressure applied to a top of both first arm 405 and second arm 505. Distance 805 may be selected by a user by applying sufficient force on a top of both first arm 405 and second arm 505 to pivot around cross pin 715.

In this manner, light diffuser device 400 may be place optical lens 105 of light diffuser device 400 over a camera lens associated with the mobile device. Upon releasing pressure from spring 720, first arm 405 and second arm 505 may return towards each other and entrap the mobile device between first arm 405 and second arm 505. Spring 720 applies pressure to maintain light diffuser device 400 in place on the mobile device and optical lens 105 over a camera lens of a camera associated with the mobile device. Light diffuser device 400 operates as a clip which itself provides pressure from spring 720 to maintain its position on a mobile device.

It is noted that light diffuser device 400 is illustrated as being implemented as a clip, as discussed above. However, light diffuser device 400 may further be implemented with any mechanism that connects or attaches light diffuser device 400 to a mobile device. For example, light diffuser device 400 may be built into a case or a cover, light diffuser device 400, may include a pocket that slides over the mobile device, light diffuser device 400 may be implemented and connected to a mobile device by magnetic connectors, hook and loop tape, adhesives (permanent or temporary), friction fit attachments, suction fit attachments, or any other mechanism for attaching light diffuser device 400 to a mobile device.

The foregoing description has been presented for purposes of illustration. It is not exhaustive and does not limit the invention to the precise forms or embodiments disclosed. Modifications and adaptations will be apparent to those skilled in the art from consideration of the specification and practice of the disclosed embodiments. For example, components described herein may be removed and other components added without departing from the scope or spirit of the embodiments disclosed herein or the appended claims.

Other embodiments will be apparent to those skilled in the art from consideration of the specification and practice of the disclosure disclosed herein. It is intended that the specification and examples be considered as exemplary only, with a true scope and spirit of the invention being indicated by the following claims.

What is claimed is:

1. A light diffuser device, comprising:
a first arm including a first pin connector and a second pin connector;
a second arm including a first pin connector and a second pin connector;
a light diffuser head connected to the first arm; and
an optical lens disposed in the light diffuser head,
wherein the first pin connector and the second pin connector of the first arm and first pin connector and the second pin connector of the second arm each include a pin aperture,
wherein a cross pin is disposed in the pin aperture connecting the first pin connector and the second pin connector to the first arm to first pin connector and the second pin connector of the second arm,
wherein spring pressure is applied by a spring disposed on the cross pin to the first arm and the second arm which biases the bottom end of the first arm and the bottom end of the second arm towards each other, the cross pin acting as a pivot point to form a clip,
wherein the light diffuser head includes a retainer which selectively retains the optical lens in the light diffuser head,
wherein the light diffuser head includes a connector, which allows the light diffuser head to connect to the first arm, and
wherein the optical lens adjusts at least one optical property of light entering through the optical lens.

2. The light diffuser device of claim 1, wherein the light diffuser head includes one or more grip enhancements.

3. The light diffuser head of claim 2, wherein the one or more grip enhancements include a texturing.

4. The light diffuser device of claim 1, wherein the retainer is disposed on a rim of the light diffuser head.

5. The light diffuser device of claim 1, wherein the connector is implemented as machine threads.

6. The light diffuser device of claim 1, wherein the first arm is tapered such that a top end of the first arm is wider than a bottom end of the first arm.

7. The light diffuser device of claim 1, wherein the second arm is tapered such that a top end of the second arm is wider than a bottom end of the second arm.

8. The light diffuser device of claim 1, wherein an exterior surface of the optical lens is disposed to be flush with a rim of the light diffuser head.

9. The light diffuser device of claim 1, wherein an exterior surface of the optical lens is disposed below a rim of the light diffuser head.

10. The light diffuser device of claim 1, wherein an exterior surface of the optical lens is disposed above a rim of the light diffuser head.

11. The light diffuser device of claim 1, wherein the optical property adjusted by the optical lens is a diffusing adjustment.

12. The light diffuser device of claim 1, wherein the optical lens is translucent and made of either plastic, quartz, or glass.

13. The light diffuser device of claim 1, wherein the optical lens includes materials that are excited by one or both of ultraviolet light radiation and infrared light radiation.

14. The light diffuser device of claim 1, wherein one optical property adjusted by the optical lens is a filtering adjustment.

15. The light diffuser device of claim 1, wherein the optical lens is sized to be applied over a camera lens of a camera in a mobile device.

16. The light diffuser device of claim 15, wherein the spring pressure on the first arm and the second arm causes the clip to attach to the mobile device such that the optical lens of the light diffuser device is installed over the camera lens of the camera in the mobile device.

17. The light diffuser device of claim 1, wherein the first arm is longer than the second arm.

18. The light diffuser device of claim 1, wherein when the first arm and the second arm are squeezed above the pivot point, the top of the first arm and the top of the second arm are pushed closer together.

19. The light diffuser device of claim 18, wherein when the first arm and the second arm are squeezed above the pivot point, the bottom of the first arm and the bottom of the second arm are separated by an increased distance.

20. The light diffuser device of claim 1, wherein the first pin connector and the second pin connector of the first arm extend from a rear surface of the first arm and the first pin connector and the second pin connector of the second arm extend from a rear surface of the second arm.
